(19) United States
(12) Patent Application Publication
(10) Pub. No.: US 2006/0175337 A1
(43) Pub. Date: Aug. 10, 2006

(54) Complex-shape compressed gas reservoirs

(76) Inventor: Josh P. Defosset, Santa Cruz, CA (US)

Correspondence Address: LEVINE BAGADE HAN LLP, 2483 EAST BAYSHORE ROAD, SUITE 100, PALO ALTO, CA, 94303, US

(21) Appl. No.: 11/035,033

(22) Filed: Jan. 12, 2005

Related U.S. Application Data
(63) Continuation-in-part of application No. 10/910,010, filed on Aug. 2, 2004.
(60) Provisional application No. 60/506,850, filed on Sep. 30, 2003.

(51) Int. Cl. F17C 1/00

(52) U.S. Cl. 220/581

(57) ABSTRACT

Portable cooling systems, employing a high pressure reservoir adapted to ergonomically interface with a user and/or a wearable article to deliver a flow of cooling gas through a conduit system are provided. Such a system is adapted to provide powered cooling to locations where only very small and portable cooling systems can fit. Various user retainable appliances or articles may have cooling features incorporated therein. The molded plastic high pressure reservoir may have other uses as well.

### RELATED APPLICATIONS

This filing is a continuation-in-part of U.S. patent application Ser. No. 10/910,010 filed Aug. 2, 2004 and claiming the benefit of Provisional Patent Application Ser. No. 60/506,850 filed Sep. 30, 2003, each of which application is incorporated by reference herein in its entirety as if specifically set forth below.

### FIELD OF THE INVENTION

This invention relates to the cooling of people or such things as race or stock animals, etc. More particularly, certain aspects of the invention are directed to user-retained or portable cooling systems, especially the supply of compressed gas for such cooling.

### BACKGROUND OF THE INVENTION

Devices to actively effect cooling fall into several basic categories. Heat pump type air-conditioning devices provide a closed loop system that compress and expand gas without releasing it in order to provide a low-temperature interface. These systems are heavy, but can be built to offer tremendous cooling loads.

Evaporative coolers (a.k.a. “swamp coolers”) use an open loop system typically relying on the evaporation of water to effect cooling. As evaporation occurs, the phase change energy of the liquid draws heat from the air. These systems work well in dry environments, but their efficiencies approach 0% as the relative humidity approaches 100%. Further, they do not work well in confined spaces, since when airflow approaches zero, so too does the evaporative cooling achieved. Still, certain cooling element inserts for garments (and, indeed, garments—vests—themselves) have been developed for soaking in water to cool by the evaporative process.

In a similar vein, other types of cooling garments have been developed that include pockets for various chillable inserts. Water, gel and more sophisticated phase change materials have been used as the thermal capacitance medium for such inserts. Endothermicly reactive packages (as in portable or on-demand ice packs) have been used in garments, helmets, etc. as well.

Still other wearable articles have been designed to include heat-exchange coils or conduits in communication with a circulating or flushing fluid source in order to cool or maintain workers or others exposed to extreme environmental conditions. The conduits and fluid in such articles may simply be provided for heat transfer purposes or, alternatively, to feed an evaporative cooling process.

As for other means of generating reduced temperatures, solid-state electronic Peltier devices are available. However, powering the same presents a mobility problem in terms of a direct electrical connection or carrying a power supply that can reduce portability. Another type of device known as a vortex tube runs on a compressed air input and outputs separate hot and cold air jets. Votrec Corporation has applied such technology to a system in which compressed air provided by a remote compressed gas source powers a vortex tube cooling apparatus which, in turn, pumps cooled air into a vest that is delivered to a user by way of a perforated lining. However, again system portability is limited by the requisite power source.

In contrast to all the above-referenced approaches, the present invention works by use of an expanding gas, preferably air. Highly pressurized gas is directed through a conduit network toward the skin of a user. In this manner, cooling is achieved both through an evaporative process as well as the low temperatures generated through gas expansion from high pressure to (low) ambient pressure.

In point of fact, both U.S. Pat. Nos. 5,438,707 and 6,009,713 to Horn also operate by directing expanding gas at a user. However, the implementation of the present invention differs dramatically. In regard to the '707 patent, it relies on relatively smaller holes or orifices in its feeder tubing to effect rapid expansion of gasses to effect cooling. As for the '713 patent, it discloses a glove including a plurality of conduits fed with pressurized gas from a gas source by way of a common manifold. No mention is made (or sign of effort shown) regarding controlling air flow delivery from the individual conduits. The glove is simply flooded with cooling air that spills out of the slits in the glove.

While the latter design may be adequate in the context of a practically unlimited compressed air supply (such as a “shop air” source), it is not suited for use on a portable basis. Where compressed gas resources are limited, a more refined approach would be desirable. Regarding the former approach, it would be desirable to provide a system that is suited for portable use, but does not require the additional expense or complexity required by the addition of terminal nozzles. As such, there exists a need for the present invention which offers a comparatively elegant system, that is additionally conservative in relation to system resources.

In connection with such a system or one that is similarly conservative of compressed gas resources there exists a need for a suitable compressed gas supply container. Known containers include Spare Air™ containers. These self-regulated emergency backup SCUBA tanks fail to provide an ergonomic character as may be required for successful commercializing of a portable cooling system. Additionally, pressure within these containers is rated at a maximum pressure of 3000 psi.

Commercially available, higher pressure, but smaller volume pressurized CO₂ containers are also available. They find use in air guns, as bicycle tire inflation devices, etc. However, again, these devices either lack the requisite volume or shape as desirable for use in a compressed gas cooling system.

Accordingly, there continues to be a need for high-pressure gas containers constructed in such a way so as to offer ergonomic options to its configuration. The present invention meets this need as well as others that might be apparent to those with skill in the art.

### SUMMARY OF THE INVENTION

In connection with the container of the present invention, there may be provided a pressurized gas cooling system in which conduits or lines exhaust air directly (i.e., without a terminal nozzle) in which the lines are tuned together (i.e., in concert) to deliver desirable—be it even, or specifically targeted—cooling flow to effect maximum cooling efficiency given pressure source supplies. An extremely effective cooling system is provided by pairing such a gas supply-efficient and structurally-efficient cooling system with a pressure vessel according to the present invention. Together, the combination comprises a further aspect of the invention.

As for the subject reservoir, it is constructed at least partially out of plastic. Typically, it is a multi-chamber construction. By interconnecting a plurality of substantially cylindrical vessel chambers, more idealized stress distributions can be achieved in design, while enjoying the benefit of a desirable form factor. For use in the cooling system, such form-factors are typically flattened and ergonomic—or complimentary to body-worn structure or apparel. In other applications, such as tight-fit situations, other shapes such as W, I, T, L, Y, C, etc. may be desirable.

Using co-molding baffle members of various shape and orientation, desirable composite reservoir structures can be formed. The baffles sections will offer support and structure to the system. Also, they provide an elegant approach to interconnecting the constituent chambers of the reservoir. Without such interconnection, ingress and egress of fluid therefrom or therebetween would require individual external plumbing to each section. Such an approach would be not only cumbersome, but also costly and possibly prone to failure. Accordingly, the baffle-type multi-chamber construction provides not only simplicity, but also a certain robustness to the system. Especially considering that the reservoirs are ideally intended for high-pressure applications, the latter factor may be particularly pertinent.

As for a preferred cooling system to be employed in a kit or combination according to the present invention, it comprises a wearable or user-retained/retainable article or appliance such as a cap, glove(s), sock(s), pants, helmet or jersey, etc. with air-handling features to provide cooling by means of release of highly compressed gas directly onto the body to be cooled.

A plenum or manifold incorporated in the wearable article is tuned to deliver fluid (gas) flow as desired. According to the preferred cooling system, this tuning is accomplished not with nozzles, but instead by way of the parameters of the conduits themselves. Namely, by way of those factors known to effect pipe flow (i.e., diameter, length, straightness vs. turns, surface finish, flowchannel or conduit shape, etc.).

A control system may be provided in the cooling system. At minimum, a user articulable valve will be provided to appropriately regulate or step-down the tank pressures from between about 600 and about 3000 psi in a preferred range to about 50 and about 500 psi. In a simple system, the valve may simply be trigger actuated by a user in order to provide a blast or pulse of cooling when desired.

A slightly more complex manner of control could involve a timer regulating any of a number of parameters from pulse frequency, length and/or pressure. Still further, by introduction of temperature sensing (e.g., sensing user skin temperature), sensing vasodialation such as by measuring local impedance, local humidity or another parameter, the system can be setup to provide automated cooling control prompted by actual user conditions or needs. The construction of such a control unit is within the abilities of those with skill in the art.

It may be desired to provide a fill system for outside source of compressed gas to fill the reservoir. Such provision will be especially beneficial in connection with a pressure vessel integrated into a unit such as a helmet (be it a motorcycle helmet, automobile helmet or of another type).

In one variation of the cooling system, the wearable article incorporating the fluid/gas conduits will be a vest or jersey in the style an athlete might wear. The vest would be worn close to the body and could feature small gage tubing running in a grid pattern throughout the fabric of the vest (the tubing, featuring a high degree of flexibility in order not to interfere with user activity). In such a case, the reservoir container could be roughly the size of a bar of soap and carried in a side or back pocket of the vest. Where more volume is required or a lower pressure reservoir is desired, a larger reservoir container may be employed.

To minimize weight and system bulk or complexity, the reservoir canister itself could feature a dial switch with “Off-Low-High” settings (the Control System) as well as a valve stem much like that of a bicycle tube (the Fill System). The user would fill the reservoir from a source of high-pressure gas, set the control system to “Low” and experience cooling in the vest through a continuous stream or short bursts of compressed gas being emitted at various points close to the skin. Increasing the control mechanism to the “High” setting will increase the duration and/or frequency of the bursts or the flow rate of the continuous delivery of compressed gas to the wearer's body. Of course, other system and control configurations are possible as well, including those elaborated upon below.

By delivering gas in a compressed state from a high pressure reservoir, the gas is still expanding as it contacts the body of the wearer. Thus the compressed gas cooling system utilizes Charles' Law of evaporative cooling which states that the temperature of any gas must drop as the pressure drops; this cooled gas provides for conductive heat transfer (cooling). Secondly, since the relative humidity of the gas originating from the high pressure reservoir is very low, it should provide for a high degree of evaporative cooling as the gas absorbs moisture from the body of the wearer and escapes the garment or such other apparatus the system may incorporate. This effect will be most pronounced in humid environments.

The compressed gas cooling system employed in connection with the subject pressure vessel advantageously allows for a minimum of impediments to the escaping gas, providing the user with the feeling of air moving by the cooling sites. That is to say, in the case of a jersey the construction is mesh or another fabric that is able to breathe, thereby allowing the decompressed/expanded air to escape from adjacent the user's body.

Another embodiment of the cooling system employs a head-worn element. One variation comprises a motorcycle, auto-racing or other hard-shelled helmet (e.g., a protective helmet such as a bicycle, football, lacrosse, fireman's, or soldier's helmet) featuring a reservoir inside the body of the helmet or connected to the helmet and a system of tubing emerging in, or running throughout, the interior of the helmet as well as a control system and fill valve.

In this variation of the invention, the conduit system may take the form of a less flexible molded unit or more flexible tubing. The control system may be separated from the rest of the system and could communicate with the rest of the system via a wire, infrared signal, radio signal or other remote actuation means. This separation of the control unit from the rest of the system could provide for user input controlling degree of cooling from the handlebar of a motorcycle or any other two handed operation the user might be engaged in. Or, the control system could be located on any easy to access surface of the helmet. Naturally, the helmet variation of the invention will be adapted to deliver compressed gas to locations near the head of the wearer and provide cooling via the same principles stated in the earlier embodiment.

In another variation of the cooling system, the user interface element is a soft cap or hat. Such a device could be worn alone or under a protective helmet such as a bicycle, football, lacrosse helmet or another type of gear, including a welders hood, etc. Due to the soft or pliable nature of this variation of the invention, the reservoir will typically be remotely located, together with any control system elements. These elements could be housed in a fanny-pack or another additional user-worn or retained structure.

Clearly, various user-retainable cooling elements or garments may be employed in connection with the high pressure reservoir of the present invention. Yet, it is especially by virtue of the subject reservoir that such cooling systems are adapted to provide powered cooling to locations where only very small and portable cooling systems can fit.

In addition, it is contemplated that the subject high pressure reservoir may find other applications. For example, it may provide a preferred type of Spare Air™ (such as produced by Submersible Systems, Inc.) system in that it can more ergonomically be set against a user's body. Other exemplary applications include fuel containers, paint dispensening (spray paint) cans, asthma or other inhaled drug bottles, CO2, N2 or other liquefied non-fuel gas (re-fillable containers or disposable cartridges), and liquid fluid containers that use pressure as a propellant means, such as disposable lubricant cans (WD-40® or 3-IN-One® Professional lubricants, cleaners such as Lysol® disinfectant sprays, or solvents such as Champion Heavy Duty Carburetor Cleaner™). In any case, it is to be understood that the invention is not limited to the uses described, and its application may vary.

### BRIEF DESCRIPTION OF THE DRAWINGS

Each of the figures diagrammatically illustrate aspects of the invention. Of these:

FIG. 1A provides an assembly view of a hard shelled helmet cooling system variation and may be used in connection with the present invention; FIG. 1B provides an assembly view of a soft-cap cooling apparatus variation;

FIGS. 2A and 2B show the front and back or reverse, respectively, of a torso jersey or torso garment;

FIGS. 3, 4A and 4B provide more detailed views of three possible conduit/line or plenum subassembly portions of the subject compressed gas cooling system;

FIGS. 5A, 5B and 6-8 illustrate aspects of a control system subassembly;

FIG. 9 is a flowchart operating one mode of operation of the subject system;

FIGS. 10 and 11 provide detailed views of refill subassemblies as may be employed in connection with the present invention;

FIGS. 12A-12D show various views of a reservoir according to the present invention, in which FIGS. 12A and 12B provide views detailing reservoir internal structure, and FIGS. 12C and 12D further illustrate the internal and external form-factor of the reservoir, respectively;

FIGS. 13A and 13C-13E show section views of further possible configurations for the subject invention; FIG. 13B shows a perspective view of a complex baffle member as may be used in either of the variations shown in FIGS. 13C and 13E;

FIGS. 14A and 14B detail the manufacturing process of the subject high pressure reservoirs; and

FIG. 15 shows a sectional end view of a reservoir produced as shown in FIGS. 14A and 14B.

Variation of the invention from that shown in the figures is contemplated. Fluid flow direction is indicated in many of the figures by arrows.

### DETAILED DESCRIPTION

Before the present invention is described in detail, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in the stated range is encompassed within the invention. Also, it is contemplated that any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail). The referenced items are provided solely for their disclosure prior to the filing date of the present application. Nothing herein is to be construed as an admission that the present invention is not entitled to antedate such material by virtue of prior invention.

Reference to a singular item, includes the possibility that there are plural of the same items present. More specifically, as used herein and in the appended claims, the singular forms “a,” “and,” “said,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs.

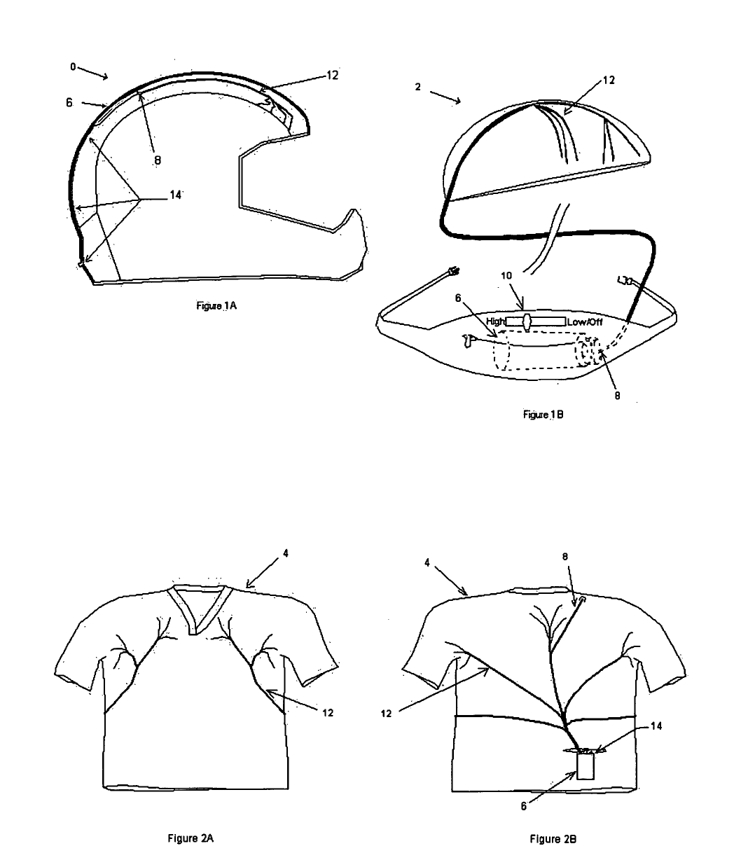

Turning now to the figures, FIG. 1A provides an assembly view of a hard shelled helmet 0 variation of a cooling apparatus as may be used with the subject reservoir. The helmet shown is a full-face motorcycle helmet. Alternatively, the helmet could be a motorcycle helmet of another style, of another style, an auto racing helmet, a bicycle helmet, or a contact sport helmet—such as a football or lacrosse helmet, etc. FIG. 1B shows another head-worn variation of the invention. Here a cap 2 is illustrated. FIGS. 2A and 2B show the front and back or reverse, respectively, of a torso jersey or torso garment 4 according to the present invention. Other possible garment formats may include a vest, tank top, etc.

Some of the differences between these systems include (as shown): the hard-shelled helmet embodiment including a reservoir 6 directly integrated into the foam liner structure of the helmet, while the cap 2 includes a reservoir in a pack 10, whereas the cooling jersey features a reservoir 6 located in a rear pocket of the garment as shown.

Next, the plenum lines 12 of the torso garment 4 must be flexible while the plenum lines 12 of the hard shell helmet could be moderately rigid. The lines in the cap may be of either nature. Finally, due to the integration of the reservoir into the foam in the hard-shelled helmet embodiment, the fill system 14 in the helmet embodiment is considerably longer than the fill system 14 shown on the torso garment 4 or as may be provided in connection with the reservoir 6 housed within pack 10 in association with the cap variation 2 of the invention.

A common characteristic between these helmet and torso cooling devices concerns the use of a lightly arced-rectangular reservoir 6 of similar volume. Furthermore, the helmet embodiment could use the same remote-type reservoir employed in/with the torso garment or cap variations of the invention shown. The integrated unit shown in the helmet is preferred for this application by virtue of its space efficiency and coordinated use with the available structure.

As for the cap or jersey/shirt embodiment, the cooling lines or conduits would likely be routed under the fabric or be housed in pockets therein. In any case, by virtue of the remote reservoir contained in each system, once the compressed gas supply is exhausted it will be changed-out or refilled in order to continue use. To refill the modular reservoir, the user would remove the reservoir from the garment 4 or pack 10 pocket and attach a supply of compressed gas to the Fill System. In the helmet embodiment, the user would remove the helmet and attach a supply of compressed gas to the fill system 14, located near the rear perimeter of the helmet.

Another optional feature of the cooling devices concerns a capped feed line 8 connected to manifold lines 12. In this manner, a single reservoir could feed two user-retained cooling systems. In this case, jersey 4 and optionally cap 2.

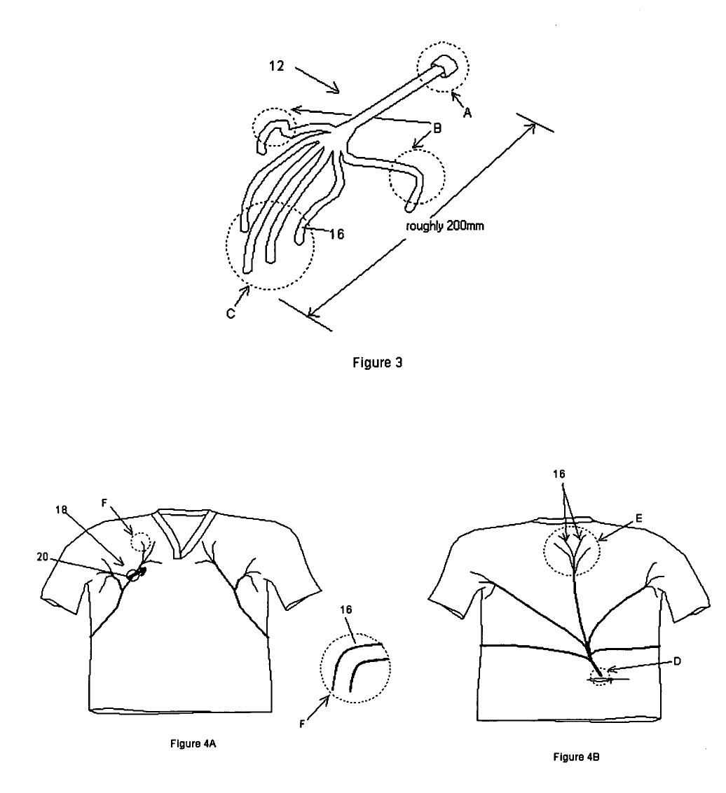

FIGS. 3, 4A and 4B provide more detailed views of three possible conduit or plenum subassembly portions of the subject compressed gas cooling system. All feature the ability to deliver, via delivery legs or conduits 12, highly compressed gas to cooling sites.

FIG. 3 shows a semi-rigid plenum or conduit system 12, such as might be used on a hard-shelled helmet. Detail “A” illustrates is where the plenum would attach to a control system (described in detail below). The other highlighted sections illustrate the “tuned system” nature of the conduit system.

Like a combustion engine exhaust system, each delivery leg of the plenum should or must have similar or equal friction to the other delivery legs. Without this “tuning” the system would be imbalanced and would supply greater cooling to the shortest delivery legs. As shown in detail “B”, the use of a supplemental “S” bend can be employed to add flow resistance of the shorter delivery conduits or legs 16 in order to balance the flow output of all delivery legs. In the alternative, tuning might be accomplished using surface roughness (variable or uniform) and different diameter sections to provide greater flow resistance/impedance.

Detail “C” illustrates that each of the delivery legs has a final aperture that faces the body to be cooled—in this case the wearer's head. Further, observe that no nozzle is provided at the distal end of the tubing; the gas exhausts through substantially straight-gauge tubing (at least over the distal end of a given conduit).

As commented upon above, the conduit system for the jersey again illustrated in FIGS. 4A and 4B offers a more flexible plenum than what may be used in the helmet. Detail “D” (like Detail A in FIG. 3, above) shows where the plenum would attach to the control system or reservoir. While this connection point is shown near the rear quarter of the garment, there are a variety of locations on the garment where the reservoir 6 and control system elements could reside.

Detail “E” again highlights the “tuned” or “balanced” nature of the system. In this case, each of the supply conduit legs 16 is tuned to have equal friction (thus, equal cooling at each dispensing site) by controlling the relationship between the number of bends, the internal diameter, and the length of each delivery leg. The shorter legs have more bends or a smaller internal diameter, while the longer legs are straighter or have larger internal diameters in order to equalize the cooling at each dispensing site (i.e., over at least one region or area to be cooled by airflow delivered by the conduit system). Detail “F” indicates that each of the delivery conduit legs 16 has a final aperture which preferably faces the body section or area to be cooled.

The placement of the branches of the cooling system will be determined by any of a variety of factors, including the subject anatomy. For example, with respect to cooling the head a more evenly distributed flow pattern may be desired. Yet, one may want to concentrate cooling toward the front of the head so cooling flow might spill-over onto the user's face where much perspiration is likely to occur. Such an approach might help dry the user's brow and aid in avoiding introducing sweat in the eyes. In a shirt or jersey, concentration of cooling to the neck (by virtue of the large blood supply therethrough) and underarms (as a well-known “hot spot”) may be preferred. However, the conduit system may be designed to deliver uniform flow over a larger area or just add more cooling sites wherein the neck and underarm cites receive greater or preferential volumes.

In addition, with a cooling system as described, switches or valves 20 may be included in order to turn “off a given branch (e.g., branch 18) of the conduit system in order to maximize cooling in another area or to conserve pressurized gas sources. As with other aspects of control of the present invention, these valves could simply be articulated or manipulated by the control system. In any case, the system can have a shut-off so as to limit cooling to a single path. However, the cooling system according to the present invention will have a plurality of cooling lines tuned to deliver respectively desired amounts of cooling flow when in an “on” condition.

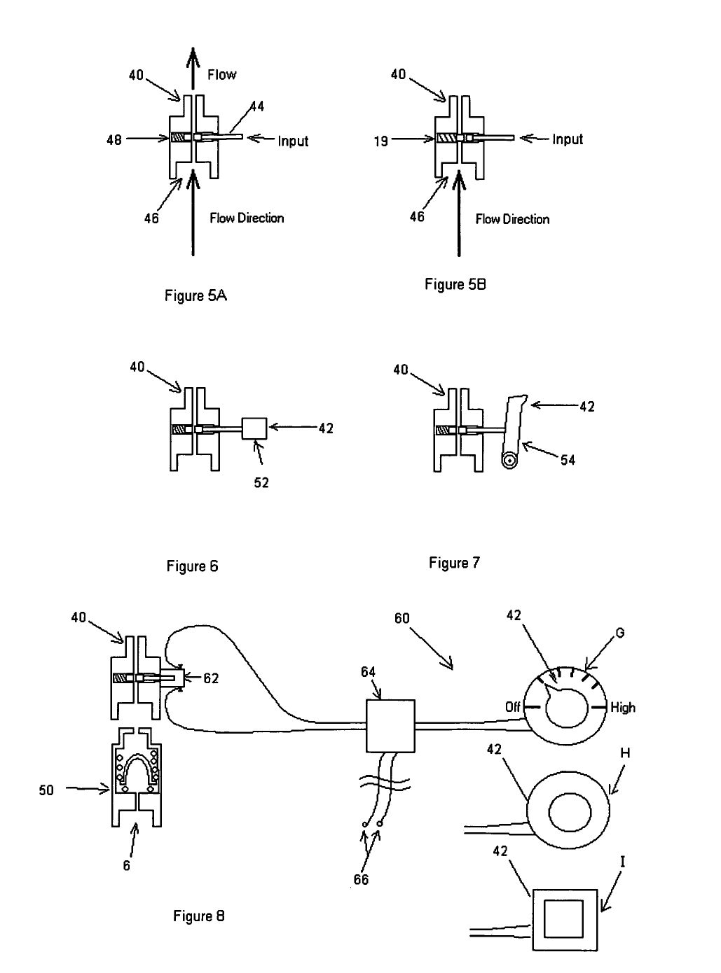

FIGS. 5A, 5B and 6-8 illustrate aspects of the control system subassembly 8. The control system comprises a valve 40 and a user control or input 42, which together are responsible for metering the gas dispensed from the reservoir to the tuned-line system to effect cooling.

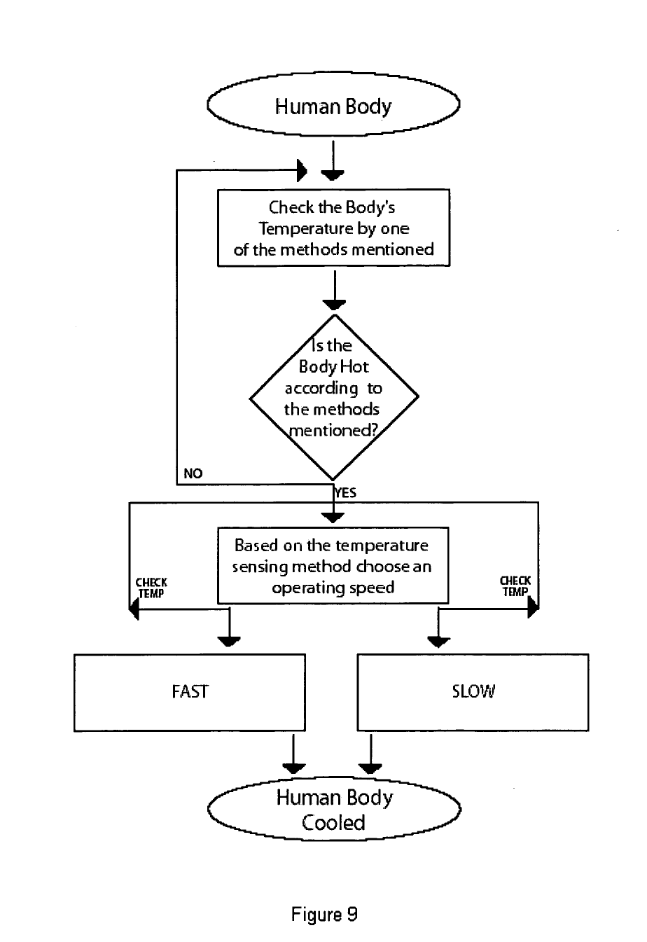

This valve is preferably capable of metering extremely high pressures (generally between 300 and 8,000 psi, though possibly higher). As shown, the valve may be a simple normally-closed valve. As illustrated in FIG. 9A, compressed gas travels through control valve 40 to the plenum delivery system when the valve is open (the user control component 42 will determine when the valve mechanism is in the open or closed position).

Typically, an actuation rod 44 is responsible for opening the valve in response to an input. A receptacle portion of the valve 46 will typically receive the reservoir. Often valve 40 may include a return spring 48, to provide the normally closed operation.

Naturally, any of a variety of valve types from various manufacturers may be employed in the present invention. For instance, Magnatrol Valve Corporation (Hawthorn, N.J.) sells various suitable valves. In addition, it is contemplated that a regulator 50 may be provided intermediate the valve and reservoir to step-down the pressure as diagrammatically illustrated in FIG. 8. Typically, an oil-less system would be preferred in this regard—though not necessary. Suitable (or adaptable) regulators are available through Thermo Electron Corporation (Fuquay, N.C.). Still further, a regulator component may be built-in to or integrated in the valve assembly.

However the valve/regulator is constructed or provided, FIGS. 6 and 7 show simple user control mechanisms. Element 52 is simply a push button to be used for dispensing gas through valve 40; whereas element 54 is a pivot lever. All manner of cams, rods, cables and other means of directly routing a user's input force to open the control valve may alternatively or additionally be employed.

In FIG. 8 a remote actuation user control system 60 is displayed. A remote actuation type of user control could allow the user to set the cooling level from a location independent of the rest of the subject compressed gas cooling system.

A solenoid or servo 62 acts in place of direct user input as in the previous approaches. The value of providing servo control is to enable the user to set the cooling level or actuate the device on-demand from a wrist strap, handlebar or steering wheel or other remote location.

In the case of remote actuation the connection is via one or more wires, the connection may be made between the input unit and solenoid 62. On the other hand, an intermediate unit 64 providing battery pack, electronics, infrared, ultrasonic or radio-frequency relay may be provided and carried or retained by the user-worn article. Such an approach can lighten the input means 42—whatever form it takes.

As for various means of providing user input in a remotely-actuated system, details “G”, “H” and “I” provide examples thereof. Detail G illustrates a dial, whereas detail H shows a simple push button. Detail I illustrates a wireless interface sending a remote signal 66.

As for the dial embodiment, it may operate as an “Off-Low-High” dial similar to the switch used for intermittent windshield wipers on modern automobiles. When in “Low” mode, the system would provide short bursts of compressed gas or slowly feed a continuous stream of compressed gas to the user; when turned up to “High” the frequency of the burst or duration of the bursts or flow rate of the continuous stream of compressed gas would increase. Of course, other means pre-set control routines may be adopted as well as user-programmed approaches. In fact, the system may be programmed (via a processor—for example in unit 64 to offer a standard cooling or bio-feedback routine with information gathered by optional thermocouple sensors 66 or other means to effect automated control). In which case, the user input may take the form of an interactive screen (either on-board, as a portable user input or in connection with a typical computer or other electronic input means).

With or without a means of user input (possibly for reason as a programming means or even an override - in order to deliver additional cooling) a program routine such as illustrated by the flowchart in FIG. 9 may be provided. The algorithm represented therein may be hard-wired or programmed logic. In the later case, a user may be afforded the option of selecting from a variety of settings to effect various levels of cooling, or customize the system set points. Such modification may be desired to account for a user's individual cooling needs, or a requirement to conserve fuel (compressed gas) supplies given the context in which the system is to be used.

The body temperature check may be provided by way of qualitative feedback from the user and/or electronic means such as a thermocouple sensor or a non-contact sensor (e.g., laser, infrared). Still further, “temperature” may be determined in reference to secondary indicia such as measurement of vasodilatation, perspiration, blood flow, etc. using known techniques. Of course, all of the above-reference modes of control are merely exemplary—though certain ones will clearly present certain advantages in terms of basic cost or efficacy.

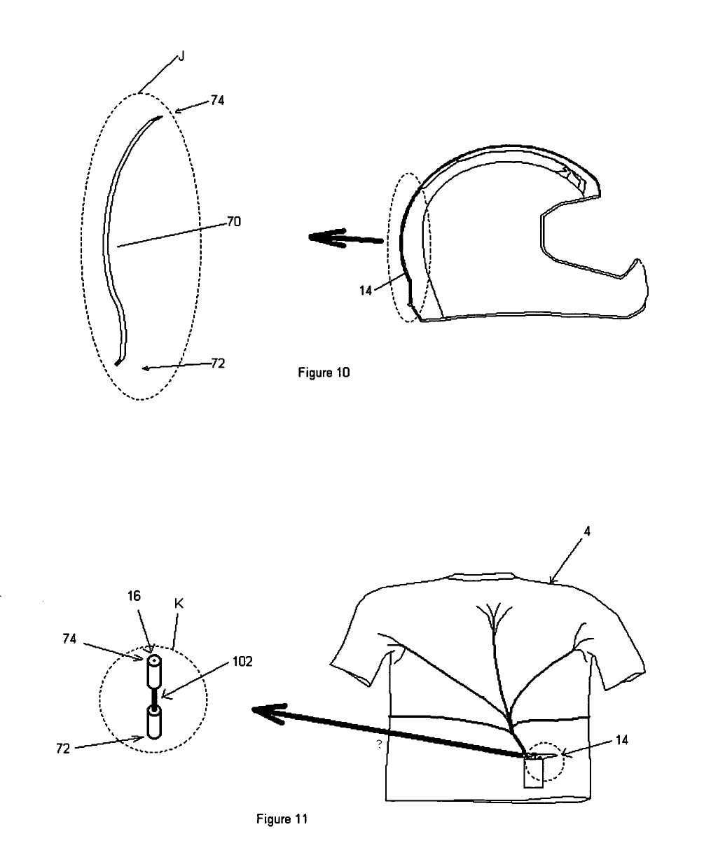

FIGS. 10 and 11 detail possible fill system subassembly 14 portions of the subject compressed gas cooling system. Detail “J” in FIG. 10 shows a fill conduit 70 following the contour of the helmet. The conduit may be integrally formed, but is preferably a discrete high pressure line. Options in this regard include braid-reinforced structure, metal conduits or high strength polymeric tubing such as PEEK.

The fill system is responsible for allowing the user to attach a supply of compressed gas and allowing that compressed gas to enter the reservoir. The fill system preferably comprises a tube or hose, with minimal expansion under pressure characteristics, which includes at least a valve 72 to allow user access, with the other end connected to the reservoir.

In the variation in detail J, valve 72 is a high-pressure valve such as a bicycle or automobile tube or tire valve, or, like the quick-disconnect fittings popular in industrial pneumatic applications. Any such valve must be capable of holding inside the highly pressurized gas from the Reservoir Assembly (likely at 300 to 8,000 psi or more). Point 74 shows the connection point to the reservoir. Actually, if desired, it is also possible that the valve referred to earlier in this section could instead be located at this end of the fill line or system instead.

The length of the fill tubing 70 is variable. Some applications, like a particular hard shelled helmet design as shown will require a longer length between the reservoir and the user fill point. While other applications, like a torso cooling garment as shown may only require a very long length between these components as shown in detail K. Actually, in some instances, it will be possible to eliminate the fill conduit altogether (for example where valve body 40 is itself adapted to accept a pressure recharging input).

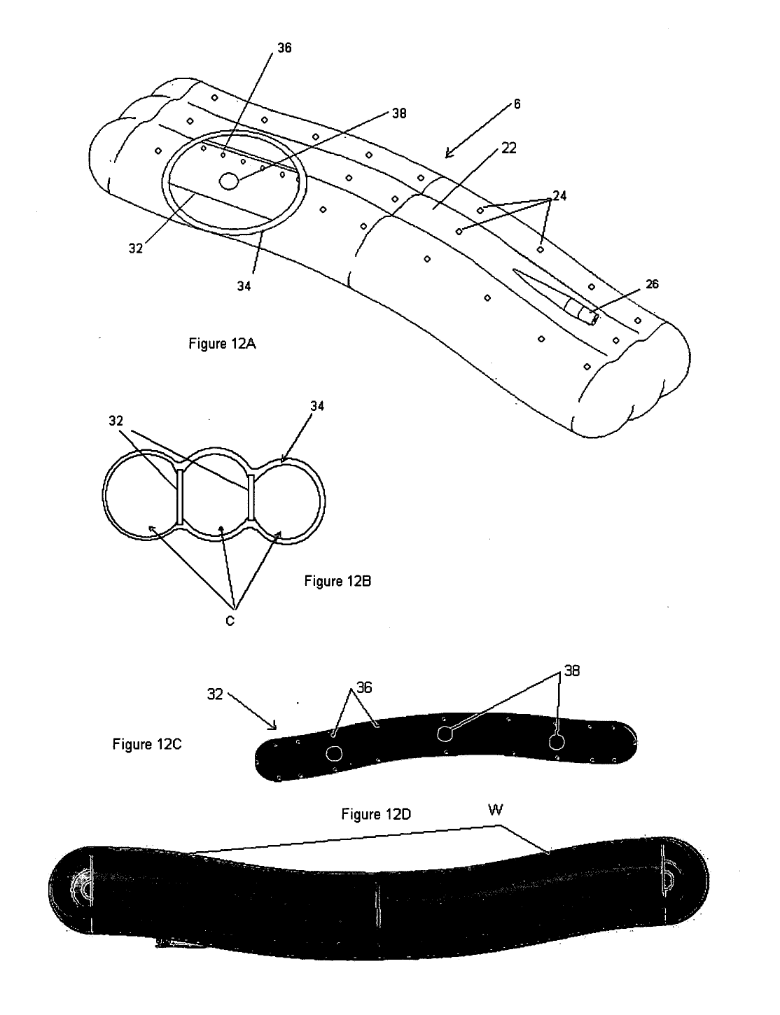

FIGS. 12A-12D show various views of one possible embodiment of the reservoir subassembly portion of the subject compressed gas cooling system. Additional reservoir variations are shown as well. All these embodiments feature the ability to hold a quantity of highly compressed gas

The upper surface 22 of reservoir 6 includes optional fracture lines or crevices 24. If provided, these features enable a controlled mechanism for failure in the case of tremendous impact to the reservoir. Such a fracture safety mechanism is to be positioned away from the user in a hard-shelled helmet or torso-cooling garment. Should the user receive a sufficient impact to cause failure, such as being hit by a car or falling from a building, the fracture crevices would ensure that the “weak links” crack and appear facing away from the user to allow the compressed gas a path to escape without the user risking undue cooling from the sudden release of compressed gas directed toward the user's body.

Regardless of whether such safety features are provided, reservoir 6 is formed of a polymer such as high strength nylon (e.g., Trogamid TX-7389 from Degussa Huls) possibly with reinforcing fibers (e.g., from 10 to 50% the final alloy by weight) by way of high pressure nitrogen assisted injection molding techniques to form the internal cavity. An exceptionally strong plastic is required for the highest pressure applications. One candidate in this regard is Ticona Celstran PA6-GF50-01 50% Long Fiber Reinforced Nylon which features an ultimate tensile strength of 35500 psi and a tensile modulus of 2320 kpsi. Using this material, for a vessel with one or more internal chambers with a diameter of about 1 inch and designed to a safety factor of 2.0 for handling 8000 psi internal pressure, a wall thickness of about 0.29 inches is employed. Other material may require different thickness for such application.

A single-chamber may be constructed with such material, according to the techniques further described below. While such a pressure vessel offers certain utility and may comprise an aspect of the invention, preferred variations according to the present invention are more complex than a simple cylinder or single cavity.

The pressure vessels of the present invention advantageously includes at least one internal septum or baffle wall 32. Such a structure is generally co-molded with the shell 34 material with interlock holes 36 to geometrically interlock the reservoir outer walls and this stress-bearing member. In order to facilitate the insert or co-molding process referred to, it is required that the thermal deflection temperature be higher in the baffle material than the resin used to mold the exterior walls of the pressure vessel. Accordingly, a good candidate material is Chevron Phillips Xtel XK2040 Polyphenylene sulfide (PPS) which has a thermal deflection temperature of 482 deg. F. Other options include Phenolic, carbon fiber, a metallic member such as aluminum or titanium alloy, or hi-temp Nylon.

The purpose of the baffles or septum walls/member(s) is to allow the pressure vessel to approximate cylindrical body pressure vessel performance, but with an exterior shape that is not round in section (i.e., without the ergonomic drawbacks of an actual exterior cylinder form factor). Baffle holes 38 are advantageously provided to equalize pressure between adjacent chambers “C” in such an arrangement.

FIGS. 12A-12D show a 3×1 type vessel construction in which the width of the vessel is roughly three times its height or thickness. Such an aspect ratio allows for a substantially flat or flattened structure facilitating ergonomic placement adjacent a user's body (e.g., along the small of the back, in a jersey or jacket pocket, integrated within a helmet, etc.). More specifically, a vessel as shown in FIGS. 12A-12D having a width of about 3.5 inches to a length of about 11.5 inches, with individual chambers having an outer diameter of about 1.5 inches, is thought to be ideal for lying across a variety of users' backs. Naturally, these dimensions may vary.

As shown in FIG. 12D, in addition to providing a relatively flattened structure, to make the reservoir more ergonomic it can be constructed with a form-fitting profile. The gentle compound curvature of the reservoir provides wing sections “W” flaring upward from the central body to provide clearance for muscles of the lower back.

Naturally, other constructions and configurations may be employed. Indeed, any form factor ranging from 2×1 to 5×1 may be advantageously used in configuration shown in FIGS. 12A-12D for placement against the small of a users back.

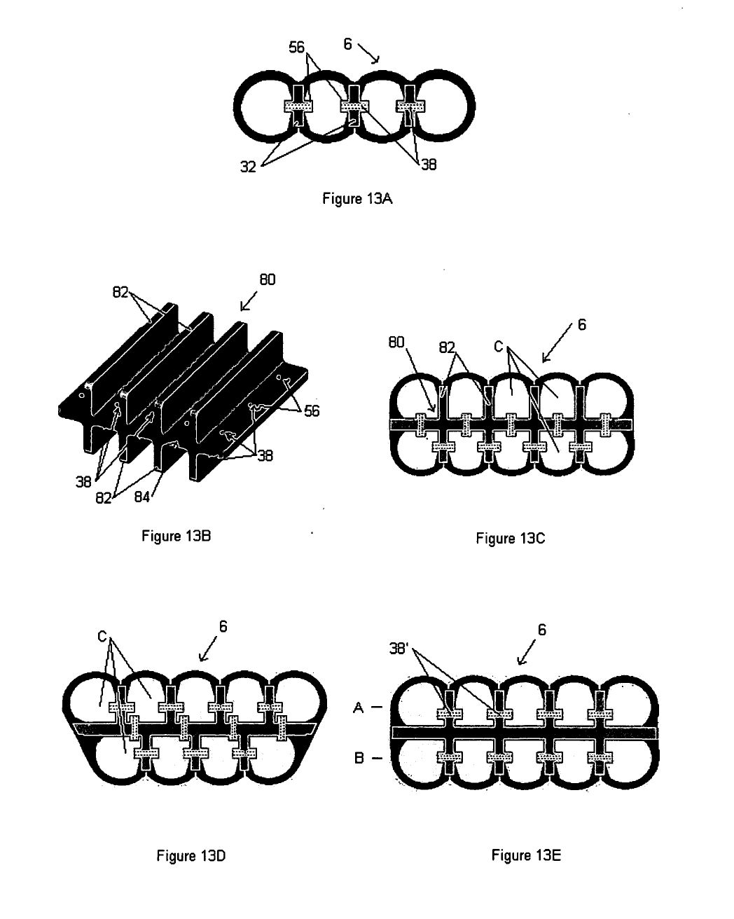

Still other options are possible in which the flattened configuration (with or without contour-matching curvature) is selected to interfit with a selected location or simply provide a low-profile reservoir. FIG. 13A shows one such alternative arrangement. Here a 4×1 reservoir structure 6 is shown. Of course, the reservoir may include numerous other side-by-side units. Upwards of 10 or 20 may be provided, or even more.

Still further, it may be desired to stack chamber units upon one another as detailed further below. Such an approach may be particularly desirable in order to reduce individual wall section (because pressure vessel wall thickness increases with vessel diameter). In this way, 5×2, 10×2, etc. vessel chamber constructions can be created. However arranged, substantially flat or flattened-style reservoirs may be thereby provided. They may have a ratio of thickness or height to width of at least about 2:1, 2.5:1, 3:1, 4:1, 5:1 or more. The “flatness” of the shape will typically be dictated by the end use. In any case, the present invention provides the requisite flexibility in design to offer these form-factors and others.

One manner of producing “stacked” arrangements of pressure vessels employs a multi-level baffle structure 80, such as shown in FIG. 13B. The baffle structure shown includes separators or fins 82 to define individual chambers “C” sections and mid-plate or wall 84 separating the stacks of chambers. To equalize pressure, baffle holes 38 provide fluid communication between the individual chamber sections. Top-to-bottom and side-to-side communication between all of the reservoir sections is facilitated by the configuration shown in FIG. 13B.

The baffle structure 80 may be setup so that individual chambers are in-line as shown in FIG. 13B to form a reservoir 6 as shown in FIG. 13C. Alternatively, the walls may be staggered to produce a reservoir 6 as shown in FIG. 13D. A staggered shape may facilitate a more closely packed arrangement of chambers “C”. Such an arrangement may require additional ports or through holes to provide total fluid communication between the chambers.

The reservoir package 6 shown in FIG. 13E comprises two isolated chambers or sets of chambers. In other words, two functional blocks of reservoirs are provided between the reservoirs. Chamber set “A” is isolated from chamber set “B” by eliminating or capping the through holes in the mid-plate 84 making it imperforate; through holes 38′ are added to provide fluid communication through chamber set A. Such an arrangement may be desirable from the perspective of having an isolated backup. In which case, it may be desirable to provide different volumes between the two.

One reason for providing two sets of chambers would be for the second set to serve as a reserve tank or backup. In this way, a firefighter using a cooling system with such a reservoir could be assured that even if he/she did not hear the “tank low” alarms, after the primary tank ran out, there was still a reserve tank of, say, about 1/10^{th} the capacity of his/her main reservoir. This would provide enough cooling to get back to the truck for a fresh tank. For other applications, more than two independent or isolated chambers may be desired.

In the arrangements shown in FIGS. 13C-13E, the walls of a two-piece mold are able to wick the plastic resin along their surface(s). As such, with baffle wall sections taking up internal space, multi-layer structures can be constructed without the use of additional mold inserts or gates. Still, aspects of the present invention are intended to cover such constructions, even though those that are shown may be preferred.

In addition, it should be appreciated that further variation in reservoir shapes may be provided in addition to those shown. Yet, for carrying against the body or inclusion in a helmet or another wearable appliance, it may be desirable that the structure is curved or otherwise ergonomically shaped in a manner similar to the examples shown.

Note that the reservoir shown in FIGS. 12A-12C includes a single input/output port 26. This may require that the fill and control system share a port. The systems may be integrated so that the control system opens the control valve not only to dispense gas but also during the fill cycle. Other arrangements are possible as well, including “Y” valve or dual-port arrangements.

The input/output port will generally have a metal nipple 28 insert molded with the rest of the pressure vessel. A 302, 303 or 304 Stainless Steel alloy may be selected for reason of low hardness (among steels) and high corrosion resistance (among stainless steels). However, an integrally-formed plastic nipple may be employed.

However constructed, the nipple may or may not have a one-way valve secondarily attached to the nipple. In the latter case, the valve may be attached to the nipple with a tamper resistant adhesive (such as Loctite™ 262, 270, 271, 272, 277 or 2760 or JB Weld™).

A one-way valve either in the nipple or permanently attached immediately downstream of the nipple will allow the user to attach and detach a regulator (as in the case of the Line Tuned Cooling System) or an aerosol spray head or any other “end use” assembly without any chance of opening a high pressure vessel. However, such a configuration may also require a special fitting for filling the pressure. Like shop pneumatic lines, this special fitting may have a specific male geometry to be inserted inside the one-way valve in order to un-lock a ball to fill or dispense gas.

Input/output port 26 may be aligned with or set some distance away from a baffle wall section 32. When aligned with a baffle wall, the wall may be relieved to provide clearance for the emergence point of the stem within the reservoir. Alternatively, the nipple and baffle wall structure may be made integral to one another. Spacing the port 26 and/or nipple 28 some distance away from baffle section(s) offers a simple solution to avoid interfering parts. Likewise, the input/output port(s) in or at the Nitrogen injection location(s) discussed below also offers a convenient solution. However, it will generally be preferred to avoid having any hardware at the ends of the reservoir that could more easily be sheared or broken off.

Regardless of configuration, the reservoir will typically be constructed employing Nitrogen assisted molding techniques. FIGS. 14A-14C illustrate the process. In each of the figures, a mold 100 with cavity halves “A” and “B” is employed. Via sprue and gate 102, 104 liquid plastic resin is injected into the assembly. Liquid/gas Nitrogen is injected into the plastic body through a retractable needle 106 before the mold halves open. As the part cools, the Nitrogen escapes leaving a part with the desired wall thickness.

The nitrogen escapes through artifact hole(s) made by the Nitrogen injection needle(s) employed. So that the reservoir will hold pressure, these holes are preferably sealed using a light-cured cyanoacrylate such as Loctite® 3341 Light Cure Acrylic Adhesive, or capped by a safety-valve assembly. A suitable valve is provided by Kunkle models 541,542 or 548. Where a safety valve is used, it may be set to open at 50% above rated pressure (i.e., safety-valve actuation will occur at 5250 psi for a Vessel rated to 3500 psi). The “safety-valve” may be resetable or re-useable as in the case of a mechanical assembly, or may be single-use, as in the case of an epoxy patch.

A more elegant approach to manufacture is to inject the nitrogen directly through the input/output port (e.g., through a mouth of a insert molded nipple fitting 28). FIG. 14B illustrates such an approach.

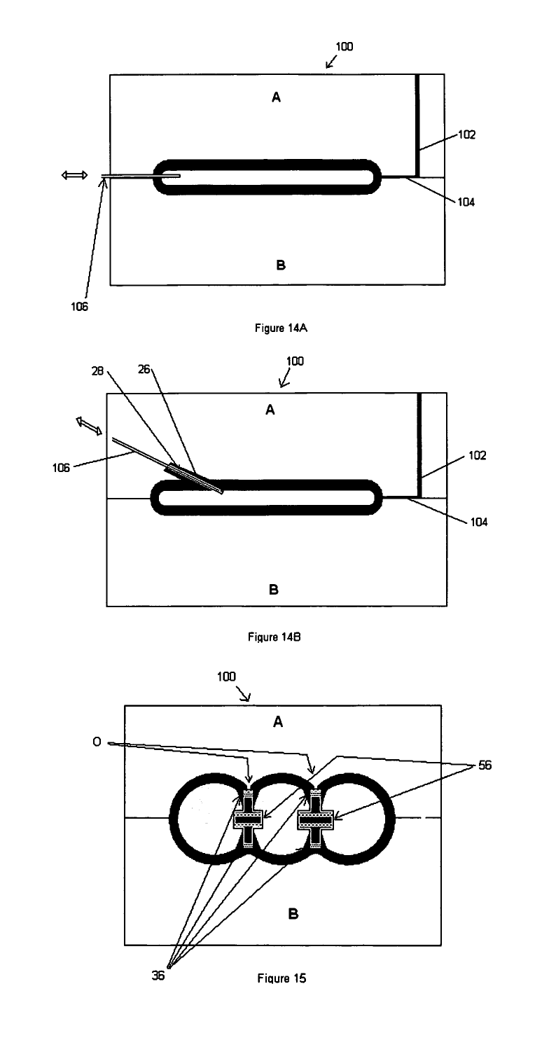

FIG. 15 provides an end-view of a mold 100, further illustrating baffle features. To support baffles 32 during molding, edges or points at their exterior may be exposed to contact support pins in the mold (not shown) as indicated by arrows “O”. Also shown are the above-referenced “knit” holes 36 in the baffles that allow liquid resin flow therein to cure and physically interlock the various components. Also shown are vent or through holes 38, with optional raised bosses 56. The purpose of the bosses is to assist to avoid resin filling the holes used to unify the compartment of the pressure vessel.

With baffle sections, pressure vessels with chambers maintaining a stress distribution similar to circular (the lowest stress distribution vessel shape) but with a different external shape can be constructed. Stated otherwise, roughly circular (or modular circular) sections can be ganged together to form other complex shapes. Each of the cambers defining the external shape are in fluid communication by virtue of holes in the baffles. In this manner, the individual chambers may be unified to serve as a single vessel, sharing an input and/or output. Thus, applications and potential form factors that can be achieved are highly variable—the examples provided above being advantageous, but non-limiting.

As for other details and constructional approaches to the present invention, materials and manufacturing techniques may be employed as within the level of those with skill in the relevant art. Though the invention has been described in reference to several examples, optionally incorporating various features, the invention is not to be limited to that which is described or indicated as contemplated with respect to each embodiment or variation of the invention.

The breadth of the present invention is to be limited only by the literal or equitable scope of the following claims. That being said, I claim:

1. A high pressure reservoir, the reservoir able to withstand at least 1000 psi internal pressure wherein the improvement consists of:
the reservoir having an injection molded plastic body.

2. The reservoir of claim 1, wherein the plastic is fiber-filled.

3. The reservoir of claim 1, wherein the reservoir comprises a plurality of chambers.

4. The reservoir of claim 3, wherein at least one baffle wall is co-molded with the injection molded plastic of the body.

5. The reservoir of claim 4, wherein the baffle includes a plurality of features around a periphery interlocking with the injection molded plastic.

6. The reservoir of claim 4, wherein the baffle defines at least one opening in fluid communication between at least two chambers.

7. The reservoir of claim 3, configured with at least two chambers in width and one chamber in height.

8. The reservoir of claim 3, configured with at least two layers of chambers in height.

9. The reservoir of claim 8, wherein the layers are closely packed with one another.

10. The reservoir of claim 1, having an ergonomic shape to interface with a user's body.

11. A high pressure reservoir, the reservoir comprising:
a flattened plastic body, the body including at least one internal baffle interlocking with opposing wall portions of the body
wherein the reservoir is able to withstand at least 1000 psi internal pressure.

12. The reservoir of claim 11, wherein the plastic is fiber-filled.

13. The reservoir of claim 11, wherein the reservoir comprises a plurality of chambers.

14. The reservoir of claim 13, wherein the chambers are substantially circular in cross-section.

15. The reservoir of claim 13, wherein the flattened body has a width to thickness ratio of at least about 2:1.

16. The reservoir of claim 15, wherein the ratio is at least about 3:1.

17. A method of making a high-pressure reservoir, the method comprising:
holding a baffle insert within a mold cavity, the baffle including a plurality interlockable features around at least a portion of a periphery,
flowing plastic into the mold cavity;
injecting high-pressure gas into the plastic to define at least one inner chamber;
flowing the plastic into engagement with the interlocking features.

18. The method of claim 17, wherein a needle to deliver the nitrogen is inserted into an air input/output nipple of the device.

19. The method of claim 18, wherein the nipple is co-molded with the plastic.

20. The method of claim 17, further comprising filling at least one hole through which the gas is injected with a pressure safety feature, and closing any remaining gas injection holes.
